(19) United States
(12) Patent Application Publication
(10) Pub. No.: US 2006/0101098 A1
(43) Pub. Date: May 11, 2006

(54) Session initiation protocol call center

(76) Inventors: David P. Morgan, Lexington, MA (US); Daniel B. Sullivan, Charlestown, MA (US); Jon A. Erickson, Scituate, MA (US); Salvatore R. Giudice, Charlestown, PA (US)

Correspondence Address: FISH & RICHARDSON PC, P.O. BOX 1022, MINNEAPOLIS, MN, 55440-1022, US

(21) Appl. No.: 10/985,165

(22) Filed: Nov. 10, 2004

(51) Int. Cl. G06F 12/00; G06F 17/30

(52) U.S. Cl. 707/204

(57) ABSTRACT

A customer service center or other facility receives session imitation protocol (SIP) messages transmitted from a web services user agent on behalf of a user network device. The customer service center is equipped with a session initiation protocol-enabled presence server that retrieves information about a SIP registered user, and adds information about the user (e.g., the user's name) on selected buddy lists subscribed to by customer service representatives. Customer service representatives are able to establish SIP media sessions with users appearing on their buddy lists by, for example, clicking on the user's name.

### TECHNICAL FIELD

This disclosure relates to using the Session Initiation Protocol (SIP).

### BACKGROUND

A customer service center is an environment in which customer service representatives field inquires (e.g., telephone inquires) from customers. Customer service representatives often have to use different customer relationship management (CRM) systems depending upon the customer inquiry. CRMs may run on different protocols. In addition, many customer service centers currently utilize a public switched telephone network (PSTN).

### SUMMARY

In one aspect, the invention feature a SIP-based customer service center that is configured to receive an process customer requests using the SIP protocol. The customer service center is also configured automatically register users who access a web site associated with the customer service center, and information about those customers on one or more buddy lists that are subscribed to by customer service agents.

In another aspect, the invention features a web services user agent that is deployed to a network device associated with a user when the user accesses a predetermined web site (e.g., a web site associated with a customer service center). The web services user agent is configured to automatically use a user's login information (e.g., a usemame and password) to generate and transmit a SIP registration message to a remote SIP server. In one particular implementation, the web services user agent is also configured to capture URLs of web pages loaded into a browser associated with the user and transmit the URLs to the remote SIP server. To protect the privacy of the user, the web service user agent may be configured to only capture URLs associated with certain web sites (e.g., a web site of a customer service center).

In another aspect, the invention features a computer-implemented method that includes receiving at a SIP server associated with a customer service center a SIP message that contains identification information about a user from a SIP user agent, and adding information about the user to one or more buddy lists subscribed to by customer service representatives of the customer service center.

Various implementations may include one or more of the following features. The addition of information about the user to buddy lists may include retrieving information about the user (e.g., user profile information) from a storage device and selecting one or more buddy lists to add information about the user based on the retrieved information.

The received SIP message may also include a URL locator of a webpage that has been loaded into a web browser running on a device associated with the user. The method may include selecting one or more buddy lists to add information about the user based on the universal resource locator in the received message.

The method may also include receiving at a web server a request from a network device associated with a user for a login web page of a web site associated with the customer service center and automatically transmitting components of a web services user agent to the network device associated with a user in response to the received web page request. The web services user agent may be configured to automatically generate a SIP registration messages using login information (e.g., a usemame and password) provided by the user and then transmit the SIP registration message to the SIP server. The SIP server may include both a SIP registration server and a SIP presence server. The web services user agent may be configured to handle subsequent SIP communication after registration.

The web services user agent may also be configured to periodically generate and transmit to the SIP server a SIP message that includes a URL of a webpage loaded in a web browser running on a device associated with the user. In this case, the method may include updating the selected buddy lists with the URL received in the most recent session initiation protocol message. To protect the privacy of the user, the web services user agent may be configured to capture a URL only if it is associated with a predetermined web site (e.g., a website associated with the customer service center).

In another aspect, the invention features a computer implemented method that includes receiving from a remote SIP user agent a SIP message includes identification information of a user and a URL of a webpage that has been loaded into a web browser running on a device associated with the user, wherein the message, and adding information about the user to one or more buddy lists selected from a plurality of buddy lists.

Various aspects may include one or more of the following features. The addition of information about the user to one or more buddy lists may include selecting one or more buddy lists to add information about the user based on the universal resource locator in the received message. Alternatively, the addition of information about the user to one or more buddy lists selected from a plurality of buddy lists may include retrieving information about the user (e.g., user profile information) from a storage device, and selecting one or more buddy lists to add information about the user based on the retrieved information. The buddy lists may be subscribed to by customer service representatives of a customer call center.

In another aspect, the invention features a system that includes a SIP server associated with a customer service center and a web services user agent associated with a user device. The SIP server is configured to receive a SIP registration message from a user and, in response, add information about the user to one or more buddy lists selected from a plurality of buddy lists subscribed to by customer service representatives of the customer service center. The web services user agent is configured to automatically generate and transmit a session initiation protocol registration message to the session initiation protocol server.

Various implementations may include one or more of the following features. The SIP server may include a SIP registration server and a SIP presence server. The SIP server may also be configured to retrieve information about the user (e.g., user profile information) from a storage device and select one or more buddy lists to add information about the user based on the retrieved information.

The web service user agent may also be configured to capture a URL of a webpage loaded in a web browser running on a device associated with the user, generate a session initiation protocol message that includes the URL of the webpage, and transmit the SIP message to the SIP server.

The system may also include a call controller configured to receive a request from a customer service representative to open a session initiation protocol media session with the user, and, in response, open a media session using a SIP back-to-back user agent.

In another aspect, the invention features a method for automatically connecting a first SIP user agent with a second SIP user agent. The method includes determining that the first SIP user agent should be connected to the second SIP user agent based on a set of rules that define when a SIP user agent should be connected to a SIP protocol user agent without a request to connect from either the first or second SIP user agent, and then connecting the first and second SIP user agents using a SIP back-to-back user agent.

Various aspect may include one or more of the following features. The set of rules may also define a media type for the connection (e.g., voice, video, or instant messaging). The back-to-back user agent may be configured to hide a network address of the first SIP user agent from the second SIP user agent, and visa versa.

In another aspect, the invention features a method for automatically connecting a first session initiation protocol user agent with a second session initiation protocol user agent that includes receiving an instruction from an external software process (e.g., a predictive dialer program) through an application programming interface to connect a first SIP user agent with a second SIP user agent and connecting the first and second SIP user agents using a SIP back-to-back user agent.

Various aspects may include one or more of the following features. The instruction may further include information specifying a media type for the connection. The back-to-back user agent may configured to hide a network address of the first session initiation protocol user agent from the second session initiation protocol user agent.

In another aspect, the invention features a method for automatically connecting a first session initiation protocol user agent with a second session initiation protocol user agent that includes receiving an instruction from the first SIP user agent to connect the first SIP user agent with a second SIP user agent and connecting the first and second SIP user agents using a SIP back-to-back user agent. Various aspects may include one or more of the following features. The instruction may also include information specifying a media type for the connection. The back-to-back user agent may be configured to hide a network address of the first SIP user agent from the second SIP user agent, and visa versa. The first user agent may be associated with a customer service representative of a customer service center and the second session user agent may associated with a customer of the customer service center.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of a SIP-enabled Customer service center.

FIG. 2A is a diagram showing a SIP presence server.

FIG. 2B is a flow chart of a process for registering a customer with a customer service center when the customer accesses a web site.

FIG. 2C is a flow chart of a process for dynamically populating buddy lists with customers who have accessed a web site.

FIG. 3 is a diagram showing a SIP outbound call server.

FIG. 4A is a diagram showing a SIP media server.

FIG. 4B is a flow chart of an access control process for a SIP media server.

### DETAILED DESCRIPTION

The Session Initiation Protocol, or SIP, is a signaling protocol for initiating, terminating, and modifying multimedia sessions with one or more participants over an Internet Protocol (IP) network and is currently defined by Internet Engineering Task Force (IETF) Network Working Group Request for Comments 2543 entitled “SIP: Session Initiation Protocol” (March 1999) and IETF Network Working Group Request for Comments 3261 (June 2002), the complete disclosures of which are incorporated herein by reference. A SIP-enabled device is a device which includes a SIP user agent (UA). A UA, which is typically implemented as a software process running on a client device (e.g., a cellular phone, Personal Data Assistant, desktop computer, etc.) takes input from a user and acts as an agent on their behalf to set up and tear down media sessions with other UAs. Once a session is set up, peer-to-peer communication is used for media transport between the participants. Multimedia sessions established by one or more SIP user agents can be set up using a variety of media forms such as voice, audio, video, instant messaging, file sharing, and gaming. Thus, a customer service center can be implemented with a single protocol (i.e., SIP) to allow the customer to interact with the customer service center using a wide variety of communication media, such as voice communication, live or pre-recorded audio/video communication, and/or instant text messaging communication.

In addition, the SIP protocol provides routing and identification information about a user agent for which a multimedia session has been established. This routing and identification information enables delivery of response messages to the UA at any connection point on the IP network. Thus, a SIP-enabled customer service center that is tied to the public Internet allows a customer to establish a media session with the service center at any connection point to the Internet. Similarly, service center representatives can establish media sessions (e.g., to respond to a customer inquiry) at any connection point, and thus are not tied to a workstation at a fixed location in a customer service center.

Moreover, SIP is based on open-source code and there are public domain tools for SIP application development that enable application developers to develop SIP server applications for communicating with existing CRM and custom business applications written in diverse programming languages such as C++ and Java. Thus, a SIP-enabled customer service center can process customer requests using a single standard protocol. In addition, a customer service system equipped with Internet telephony capabilities avoids reliance on the Public Switched Telephone Network (PSTN) to handle customer calls, and thus offers a potential cost savings over a traditional PSTN-based customer service center.

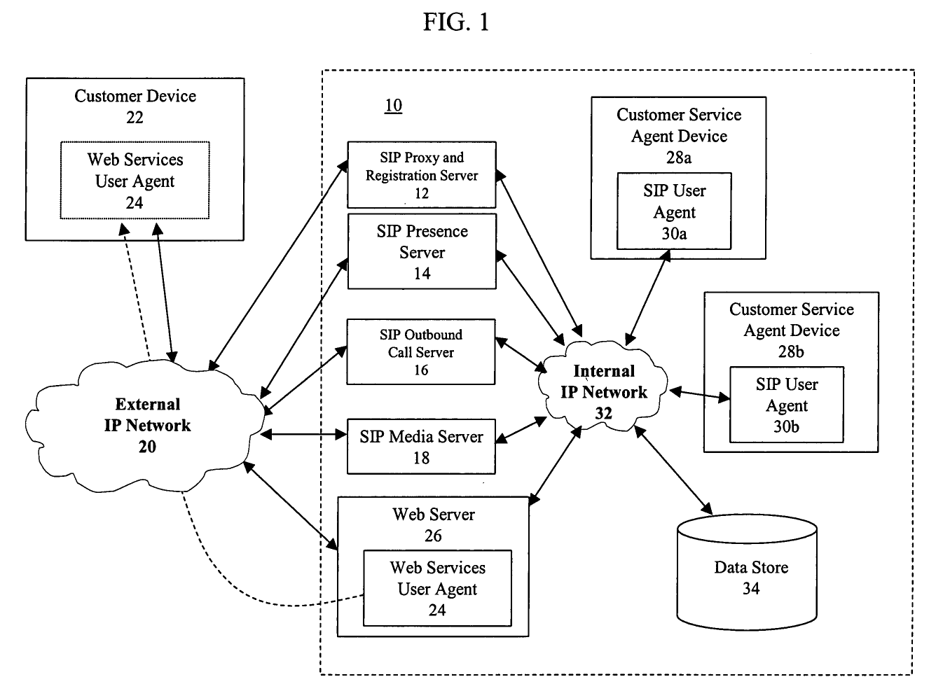

As shown in FIG. 1, an exemplary customer service center 10 uses the Session Initiation Protocol (SIP) to communicate with a remote customer device 22 over an external Internet Protocol (IP) network 20 such as the Internet. The customer service center 10 includes a SIP registration and proxy server 12, a SIP presence server 14, a SIP outbound call server 16, a SIP media server 18, and a web server 26 that are each in communication with the remote customer devices (e.g., customer device 22) using an external IP network 20. The customer service center also includes customer service representative devices 28a, 28b and a data store 34 that communicates with the SIP servers and media server using an internal IP network 32.

The customer service representative devices 28a, 28b are used by customer service representatives to communicate with users (e.g., a customer associated with device 22). Each customer service representative device 28a, 28b includes a SIP user agent 30a, 30b which operates in accordance with RFC 2543 and handles SIP request and response messages.

In some implementations, the service center devices 28a, 28b are computer workstations that include software and hardware components that provide web browsing, instant messaging, and voice-over-IP telephony capabilities. In some implementations, the service center devices 28a, 28b are also equipped with video cameras and associated software to provide video conferencing between a customer service representative and a customer.

The web server 26 is configured to provide a public website for the company associated with the customer service center 10 and requires customers to log into the website for access to its content. When a customer (e.g., the customer associated with customer device 22) logs into the website, the web server 26 automatically uploads (indicated by the dashed line) a web services user agent 24 to the customer device 22. The web services UA is an applet that provides a SIP UA for the customer device as well as a number of services designed to enhance the level of customer support provided by the customer service center.

In some implementations, the web services UA 24 automatically performs a SIP registration with the customer device with the customer service center via the SIP registration and proxy server 12. Once the web services UA registers the customer device with the SIP registration and proxy server, the web services UA periodically transmits to the SIP registration and proxy server 12 the URL (Uniform Resource Locator) of the web page loaded on the customer's web browser. The web services UA is preferably configured only to send URLs associated with the web pages of the company (e.g., the URL of a web page for opening a new account). By periodically transmitting the URL of the web pages being browsed by the customer, customer service representatives can proactively assist customers with problems. For example, if the URLs transmitted by the web services UA indicate that the customer has been on a web page to open a new account for 10 minutes when the page should take only 3 minutes to complete, a customer service representative may be alerted to this and can contact the customer to offer assistance.

In some implementations, the web services UA includes a module that automatically executes executable code contained in the body of SIP messages transmitted by the customer service center. By including a code execution applet in the web services UA, unique service applications can be provided on the remote device, for example code that retrieves and displays live stock ticker information on the stocks in the customer's portfolio.

While the web services UA is described in these implementations as run on the customer device, other implementations may include a web services UA that runs on a proxy device (e.g., a web server) on behalf of the customer device.

Referring again to FIG. 1, the customer device 22 includes hardware and software components that enable the customer to communicate with the customer service center using, for example, instant messaging, and/or voice over IP. Some customer devices may be equipped with video cameras and the appropriate software for communicating with the customer service center via video conferencing.

The SIP media server 18 and SIP registration and proxy server 12 function as the primary servers for handling inbound customer communications.

The SIP registration and proxy server 12 combines the functions of a SIP proxy server and a SIP registration server. A proxy server receives a SIP call setup message, referred to as INVITE message, from either a calling device or another proxy server and acts on its behalf to forward or respond to the request. The proxy server uses a database or location service to find the called device. A registration server accepts SIP Register requests and authenticates the UA. When the SIP UA has been authenticated, that customer is referred to as being “registered.”

When the customer service center receives a SIP Register request message from a customer, the SIP registration and proxy server 12 authenticates the customer credentials presented in the SIP request message, and, assuming the credentials are authenticated, registers the calling party (i.e., the customer) with a SIP URI. SIP registration servers can also use a RADIUS (Remote Authentication Dial In User Service)-compliant server for authenticating with a Lightweight Directory Access Protocol (LDAP) interface, so the SIP registration server has the ability to access the user's web credentials to authenticate as well.

The SIP media server 18 receives SIP requests and extracts information from the SIP request message and routes the call to an appropriate destination based on the extracted information. For example, a customer may place a voice-over-IP call to a telephone number (e.g., 617-476-9827), which causes the customer's SIP user agent to generate and transmit a SIP INVITE message to the customer service center. The header of a SIP INVITE message may contain the following information:

INVITE sip:6174769827@call.fmr.com SIP/2.0

Via: SIP/2.0/UDP node.companyx.com:5060;branch=z9hG4bK74b21

Max-Forwards: 70

From: NUT <sip:JOE@companyx.com>;tag=9fxced76sl

To: UA1 <sip:6174769827@call.fmr.com>

Call-ID: 2xTb9vxSit55XU7p8@companyx.com

CSeq: 2 INVITE

Contact: <sip:JOE@node.companyx.com>

Proxy-Authorization: Digest usemame=“JOE”,
realm=“companyx.com”,
nonce=“1cec4341ae6cbe5a359ea9c8e88df84f”, opaque=””,
qop=auth, nc=00000004, cnonce=“6f54al49”,
uri=“sip:916174769827@call.fmr.com ”,
response=“b51e504e73af54829e4f2bd7f8dc4654”

Content-Type: application/sdp

User-Agent: X-Lite release 1103a

Content-Length: 151

In this example, the SIP request message is an INVITE message that requests a voice-over-IP session with a user agent at phone number 617-476-9827. The “Via” field indicates the proxy server from which the message was forwarded (i.e., proxy server node.companyx.com). The “From” and “To” fields provide the Universal Resource Identifier (URI) of the sender and recipient of message (i.e., JOE@node.companyx.com is the sender and 6174769827@fmr.com is the recipient). The “Proxy-Authorization” field provides the “username,” the user realm to which it is authenticated, and an encrypted user name and password (this is the information used by the SIP registration and proxy server to validate and register the message). The “User-Agent” field identifies the UA being deployed on the sender's device.

SIP signaling is typically conducted over TCP (transmission control protocol) with TLS (transmission layer security) encryption. User registration is typically performed using TCP with the Digest method for encrypting the user's credentials (RSA and MD5 are other popular encryption methods). The user's credentials are provided in the “Authorization” field of the SIP header along with realm, or name, of the SIP registration server the user is authenticating to. The media traffic is transported using RTP, or for encrypted media, secure RTP (real-time transport protocol).

When the SIP media server receives this message, it extracts information from the header and routes the call to an appropriate customer service representative. For example, the SIP media server may be configured to extract the “From” field to identify the customer and then look up information about the customer in a customer profile stored on the data store 34. If the customer's profile indicates that the customer is a high net-worth customer, the SIP media server may route the SIP request message to a UA of a customer service representative dedicated to servicing high net-worth customers. Alternatively, the SIP media server may be configured to limit or restrict access to the customer service center. For example, if the SIP media server determines that the customer associated with the incoming SIP request message is only authorized to access the customer service center at certain hours or for a certain amount of time per month, the SIP media server may check to ensure (by accessing information stored in the data store) that the customer is authorized to access the customer service center.

The data store 34, which can be realized, for example, through any combination of data structures stored in memory, disk or on a database, stores the following SIP-related attributes:
1. SIP message attribute data, which is data extracted from fields within the header or body of a SIP message (e.g., a URI in the “From” or “To” field in the SIP message). These may used by the SIP Media server to determine access rights to the customer service center and to route the SIP messages to appropriate destinations.
2. Call attribute data, which are attributes associated with a SIP request message but not contained within the message itself. Examples of call attribute data is the location, time, or sequence of the call and pre-stored information about a remote device associated with a customer (e.g., a model number, capabilities, and characteristics of the remote device). This information may be used by the SIP media server to route and prioritize incoming SIP request messages.
3. Customer-entered data, which is data entered by a customer through the customer's device after the SIP session has been established. For example, the SIP media server may route all incoming voice-over-IP calls to an interactive application that prompts the customer for information about the subject matter of the call (e.g., request account balance, open a new account, speak to a customer service representative, etc.). The customer-entered data may be data (e.g., DTMF entry, alpha-numeric data, mouse click, etc.) entered by the customer in response to the interactive application. This data may then be used by the Media Server to route the call to the appropriate destination.
4. Customer profile data, which is pre-stored profile data about a customer.

Such data can include personal information (e.g., customer age, date of birth, social security number, address, blood type, etc.) and product information associated with the customer (e.g., accounts held by the customer, products purchased by the customer, etc.). Profile data also can include information that has been set up in the past, such as a “buddy” list for instant messaging. Other examples of profile data 142 can include executable code to be passed in a SIP body message to the device, previous call detail records itemizing prior service usage, and the access level permitted for the customer.
5. Customer authentication data, which is data used to validate customer credentials presented in the SIP request message. The customer authentication data can be used by the SIP media server to limit or restrict access to various applications available through the customer service center.
6. Location database, which is a database that provides the location of registered users, known URIs, and proxy servers for forwarding SIP messages. In some implementations, the location of SIP URIs also can be determined from a location service, such as Electronic Numbering (ENUM), which is a protocol developed for fetching Universal Resource Identifiers (URIs) based on a given electronic number.
7. Service center representative profile data, which is pre-stored data about customer service representatives associated with the customer service center. For example, certain customer service representatives may have special language skills or may be dedicated to servicing particular types of customers (e.g., high net-worth customers) that could be recorded in their profiles. Similarly, profile data can include information restricting service center representatives from accessing certain applications provided in the customer service center.
8. Presence/state repository, which is a repository of status information of all customers or service center representatives who are currently registered by the SIP registration and proxy server. The presence status may include status regarding “online,” “busy,” “do not disturb,” and other states.
9. User attribute data, which is non-pre-stored data associated with a user (e.g., a customer) that is registered by the SIP registration. Examples of user attribute data includes a web page currently being browsed by a user, the position of the user's mouse on their screen, and active java scripts running within the user's browser. In some implementations, user attributes are populated by external data sources and applications.

The SIP presence server 14 functions to dynamically compose and update buddy lists containing names and other information about customer's who have logged onto the web server 26 on the service center representative's devices 28a, 28b. A buddy list is a list or collection of network identities to which a user wishes to subscribe to their status or presence information. In some implementations, the SIP presence server applies a set of rules to update particular buddy lists based on information about the detected customer. The buddy lists are, in turn, subscribed to by various customer service representatives. For example, if the SIP presence server detects that customer “A” is browsing the predetermined website, the SIP presence server may lookup information about customer “A” in the data store and determine that customer “A” is a Spanish-speaking customer. In this case, the SIP presence server would update customer A's information on a buddy list that lists Spanish-speaking customers which is subscribed to by Spanish-speaking customer service representatives. In addition to routing registered customers to customer service representatives, the SIP presence server also retrieves and routes the URL most recently displayed in the customer's browser to be displayed along with the customer's name. Thus the customer service representatives see both the name of the customer who is logged onto the company website as well as the URL of the webpage on the company website that the customer is currently viewing on his or her browser.

The SIP outbound call server 16 functions to establish SIP communications between a customer service representative and a selected customer. For example, if a customer appears on a customer service representative's buddy list, the customer service representative may choose to initiate communication (e.g., a voice over IP call, or a instant message) with the customer (e.g., by clicking on the customer's name on the buddy list). The SIP outbound call server determines a URI to which communication for the selected customer should be sent and transmits a SIP request message to that URI to establish communication with the customer.

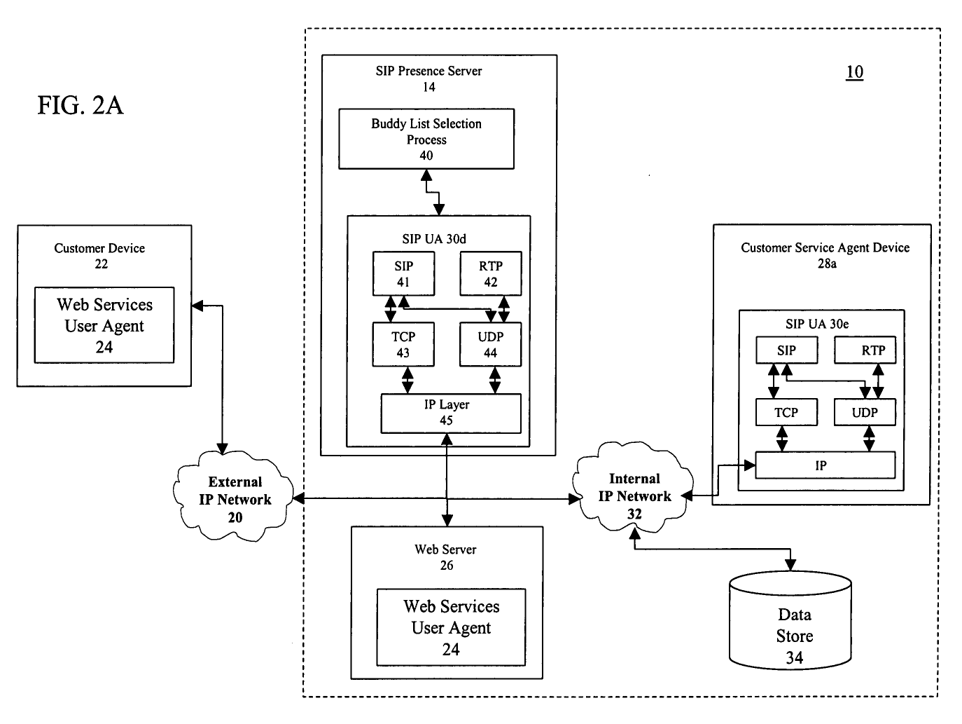

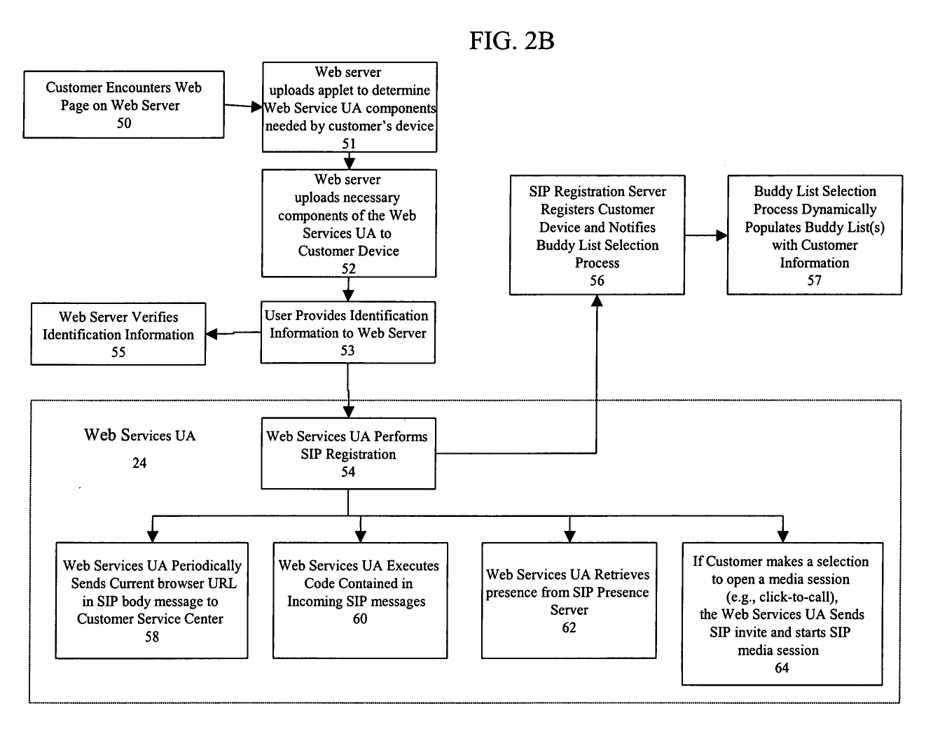

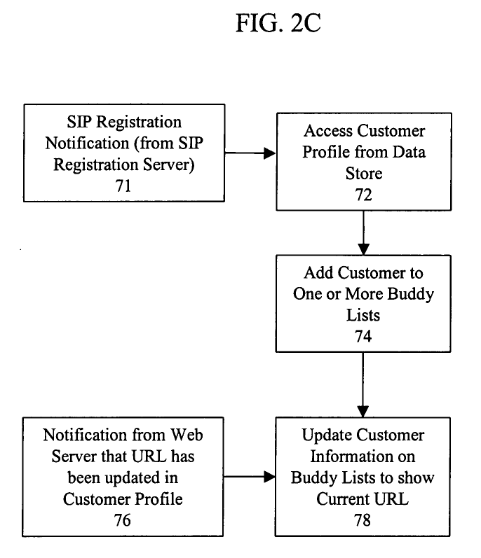

Referring to FIG. 2A, a SIP presence server 14 includes a SIP user agent 30d and a buddy list selection process 40. The SIP user agent 30d operates in accordance with RFC 2543 and includes a SIP layer, a RTP layer, a TCP layer, a UDP (user datagram protocol) layer, and an IP layer. In addition, the SIP presence server also includes a presence agent (PA) (not shown) that generates state notifications in response to requests as defined by the SIP event specification in RFC 3265.

The SIP presence server 14 includes a buddy list selection process 40 that dynamically populates buddy lists of service center representatives with the identities of customers who are logged on the company website as well as the URL associated with the company website currently being viewed by the customer. FIGS. 2B-2C illustrate operation of the web services UA and the buddy list selection process.

As shown in FIG. 2B, when a customer encounters (50) a login page on the web server, the web server automatically uploads (51) an applet to the customer's device that reports back to the web server with the capabilities of the customer's device. For example, the applet may determine and transmit a message to the web server indicating that the customer's remote device is running Microsoft Windows XP or CE as its operating system, and therefore, includes underlying SIP software for voice and media capabilities. The web server would not have to upload these software components to the customer's device.

After the applet reports back to the web server the information regarding the capabilities of the customer's device, the web server determines and uploads (52) necessary components of the web services UA. In the above example, if the web server receives a message from the customer device indicating that it is running Microsoft Windows XP or CE, then the web server would not needlessly upload software for voice and media capabilities are part of the web services UA. The uploaded web services components automatically installs themselves in the temporal memory layer of the customer device.

Prior to authentication to the web server, the customer's identity is unknown. However, when the customer provides (53) his identification information on the login page, the web server verifies (55) the information, and, if valid, permits access to the web site. Identification information is preferably login information, which is information that is sufficient to both identify and authenticate the user. A usemame and password are the most common example of login information, however, other examples of login information include user's telephone number, account number, and the last four digits of the user's social security number.

The web service UA captures the user's identification information as it is entered and generates (54) a SIP registration message to the SIP registration and proxy server 12 (shown in FIG. 1). The SIP registration and proxy server verifies the customer's login information, and, if valid, registers (56) the customer with the customer service center. Once the customer is registered with the customer service center, the web services UA preferably displays a status message indicating that the customer is connected with the customer service center.

Once the customer is successfully registered by the SIP registration and proxy server, the SIP registration and proxy server notifies the buddy list selection process 40 on the SIP presence server 14 that a customer has been registered and provides information (extracted from the SIP registration message) that identifies the customer. The buddy list selection process 40 then accesses the profile of the customer stored on the data store 34 to populate (57) buddy lists subscribed to by one or more customer service representatives. Thus, when a customer name appears on a representative's buddy list, the representative is aware that the customer is browsing or has recently browsed the company website. The representative may elect to initiate a SIP session with the customer (e.g., to solicit the customer for new business) by clicking on the customer's name on the buddy list.

In addition to automatically registering the customer device with the SIP registration and proxy server, the web services UA also monitors and transmits (58) the URL of web pages browsed by the customer to the customer service center. To do this, the web services user agent records each URL loaded into the customer's web browser, and transmits a SIP message with a list of the web pages to the SIP proxy and registration server at the customer service center. To protect the privacy of the customer, the web services UA may be configured to only record the URLs of web pages that are associated with a predetermined website such as a website of the company associated with the customer service center.

The web services user agent also automatically searches the body of incoming SIP messages for executable programs and, if executable code is detected, it automatically executes (60) the code on the customer's device. The executable code in the SIP messages can contain both generic functions, such as downloading sports statistics in real-time, or customer-specific functions, such as notifying the customer of a voice message, or a stock trade execution.

The web services user agent may also display a buddy list (62) of available customer service representatives on a display associated with the customer's device. The customer service center may be configured to have certain customers assigned to certain customer service representatives. After a web services user agent registers with the SIP registration and proxy server, the SIP registration and proxy server sends a SIP message containing an executable code module containing the customer's buddy list of assigned representatives who are logged into the customer service center. When the web service user agent receives the SIP message, it automatically executes the code module and displays a list of the customer's assigned representatives. Thus, a customer may not see all of the representatives logged onto the customer service center, but only sees those customer service representatives who are logged on and have been assigned to a buddy list associated with the customer.

The web services user agent also enables click-to-media functions, such as “click-to-call”, “click-to-see”, “click-to-chat”, and “click-to-game”, by generating and transmitting a SIP request message to the SIP media server. Thus, when the customer clicks on an item on the web page (e.g., a button asking to call a customer service representative), the web services user agent composes and sends (64) a SIP INVITE message to the SIP media server which will select a SIP user agent associated with an appropriate customer service representative to open a media session.

As shown in FIG. 2C, when a user agent registers with the SIP registration and proxy server, the SIP registration and proxy server sends a notification message (71) to the buddy list selection process 40 running on the SIP presence server. When the buddy list selection process receives the notification message, it accesses (72) the customer's profile from the data store. The buddy list selection process 40 can identify the customer from the SIP registration in a number of ways. For example, the customer can be identified by extracting information out of the “FROM” field in a SIP request message. Alternatively, the customer's identity can be a passed to the buddy list selection process by the SIP registration and proxy server that verifies the customer's login information (e.g., a user name and password).

Once the customer profile is accessed, the buddy list selection process adds (74) the customer to one or more internal buddy lists for the customer service center. These internal buddy lists are subscribed to by various representatives according to their capabilities and work assignments. The buddy list selection process preferably uses a set of rules to match customers with representatives. For example, there may be a rule that specifies that Spanish-speaking customers are placed in certain buddy lists that are subscribed to by Spanish-speaking customer service representatives. As another example, customer's of a financial services company having a accounts with a value of above a certain amount may be placed on a “preferred customer” buddy list that are subscribed to by the most experienced or highest-rated customer service representatives. Other examples include matching a customer's probable area of inquiry (determined based on the web page browsed by the user) with buddy lists to which representative's with that particular area of expertise are subscribed. The buddy list selection process 40 populates the selected buddy lists with information about the customer, including the customer's name and the URL currently loaded in the customer's browser.

As the SIP proxy and registration server updates the data store with URLs received from the web services UA, the web server transmits a notification (76) to the buddy list selection process that such an update has occurred. When the buddy list selection process receives the notification, it accesses the data store and updates the buddy lists with the current URL loaded in the customer's browser.

A customer service representative may choose to establish contact with a customer who appears on her buddy list by clicking on a customer's name on the list. When the representative clicks the name of a customer on her buddy list, a SIP INVITE message is sent from the representative's device to the SIP outbound call server. The representative has the option of either contacting a customer individually via voice, video, or instant messaging media, or she can simultaneously interact with multiple users via an instant messaging media.

The presence server 14 may interact with customer device 22 and service center devices 28a, 18b using the SIP “Subscribe,” “Notify,” or “Message” methods. The “Subscribe” method establishes requests for state information and notifications pertaining to a SIP address. Thus, the process of adding the customer to a representative's buddy list entails subscribing to presence server 14 for the state of that person, as registered with a specific SIP URI. On the other hand, the “Notify” method conveys information regarding a change in state for the subscriber. For example when a customer's state changes from “available” to “busy,” presence server 14 sends all subscribing UAs a SIP “Notify” message indicating this state change. Finally, the “Message” method is used to transport instant messages between the UAs using SIP.

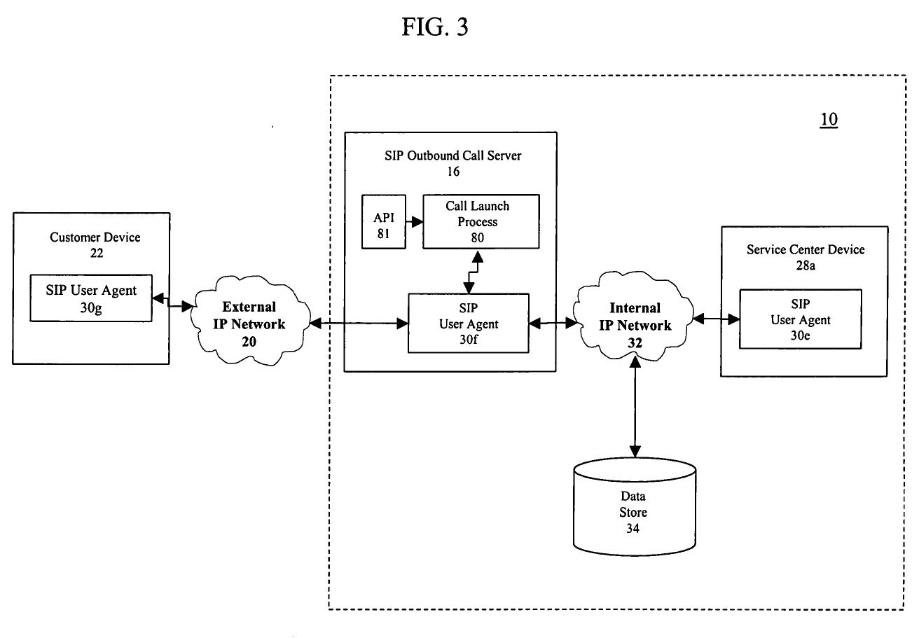

Referring to FIG. 3, the outbound call server 16 includes a SIP user agent 30f, an application program interface (API) 81, and call launch process 80. The call launch process 80 is a process which launches a SIP media session (e.g., an instant text messaging session, a voice-over-IP session, etc.) between two parties. The API 81 provides an interface for external programs (e.g., a predictive dialer program) to control the call control process 80 to launch calls.

In a preferred implementation, the call launch process 80 can be triggered to launch a SIP media session in any of the following three ways:

1. A customer service representative initiates contact with a customer by, for example, single or double clicking on the customer's name on a graphical user interface that includes the buddy list. In this case, a SIP user agent running on the customer service representative's device transmits a SIP request message to the SIP outbound call server 16 where it is handled by the call launch process 80. The call launch process 80 determines the recipient of the message by extracting information from the “To” field of the SIP request message and then retrieving a unique IP address or URI for the recipient by looking up her information within the location database of the data store 34. Once the address for the recipient is located, the outbound call server 16 transmits a SIP INVITE message to the recipient. Moreover, the message is sent using a media format (e.g., instant messaging, voice-over-IP call) selected by the customer service representative. In another implementation, an automated instant messaging robot (“bot”) can be configured to place an outbound call. A “bot” contains a significant knowledge base of a particular domain, and uses complex logic to interact with users within that domain.

2. An external call control process directs the call launch process 80 through the API 81 to launch a SIP media session. One example of an external call control process that may use the call launch process to start media sessions is a predictive dialer program, which is used widely in call centers for outbound calling campaigns. In this example, the predictive dialer process may use the call launch process to start media session between selected customers (e.g., customers who are the target of the calling campaign) with customer service representatives who have a SIP user agent that is in an “available” state.

3. The call launch process automatically starts a SIP media session between a customer service representative and a customer without initiation from the customer service representative or an external call control process. In this case, the call launch process uses pre-programmed logic to automatically connect a customer with an available customer service representative. The pre-programmed logic can by any set of rules that define when two parties should be automatically connected. For example, if the call control process 80 detects that a customer has accessed a certain web page of the company website (e.g., an open account web page), the call control process may be programmed to automatically launch a SIP instant messaging session with a customer service representative who has a SIP user agent that is in an “available” state and who belongs to skill group relevant to the accessed web page (e.g., a representative belonging to a skill group of persons knowledgeable about opening new accounts). Thus, shortly after the customer accesses the new accounts webpage, an instant message box appears on their screen with a message offering assistance from a customer service representative. In this example, the call control process 80 can look up information about available customer service representatives in the data store 34 to determine whether any available representative matches a skill group that is relevant to the web page. Similarly, the call control process 80 can look up information about the customer (e.g., the customer's unique IP address) to generate a SIP invite message to the customer.

However the call launch process is triggered, the call launch process 80 sits in the communication path between the representative and customer SIP user agents, and uses a back-to-back user agent (B2BUA) described in the SIP protocol to set up a connection between the representative and customer. The B2BUA receives a SIP request, terminates it, and then originates a new request to the destination. One advantage of the B2BUA is that the IP address of the other endpoint is not available to either end device. Thus, the B2BUA advantageously protects the privacy of the customer from the representative (and vice versa). The call launch process is also preferably configured to perform some logic between the time it terminates a first session and originates a second session, for example to conduct session encryption/decryption and/or network address translation in firewalls.

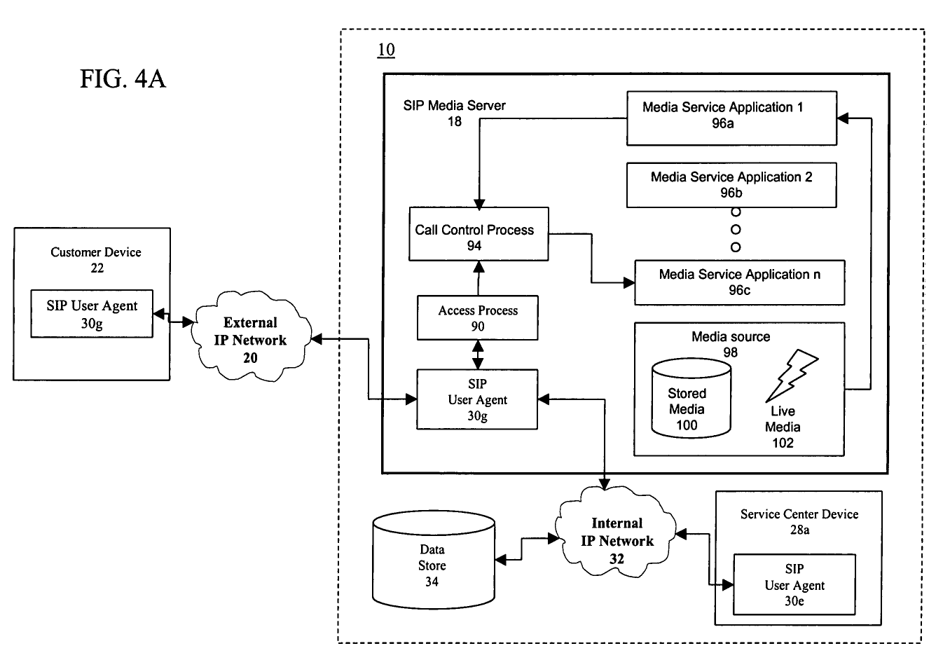

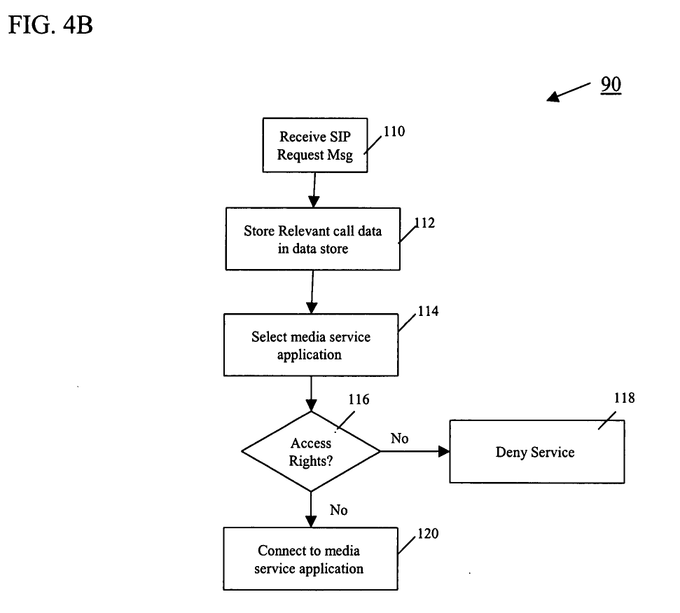

Referring to FIG. 4A, the SIP media server 18 includes an access control process 90, a call control process 92, several media applications 96a-96c and a media source 98. As previously mentioned, the primary function of the media server 18 is to respond to incoming SIP requests (e.g., an incoming SIP request to start a media session from a customer). Thus, the SIP media server 18 performs activities available to a conventional voice response unit (VRU), but using a number of different media, such as voice, video, instant messaging, and gaming media.

The media source 98, which can be part of media server (as shown) or reside externally in one or more electronic data sources, includes stored media 100 (e.g., ring tones, encoded music, audio and/or video segments, etc.) and live media feeds 102 (e.g., live radio shows, real-time televised broadcasts, stock market ticker line, etc.).

The media service applications 96a-96c are applications that provide media to the callers and permit their participation during real-time and interactive activities. Generally, media service applications 96a-96c rely on a customer interaction mechanism (e.g., voice, mouse, keypad) that allows the caller to navigate the application and select the desired media from media source 98.

The access process 90 functions to control access to media applications requested by incoming SIP request messages received from customers. The call control process 92 functions to route the SIP request messages to the appropriate media application.

Referring to FIG. 4B, a media server access process 90, receives (110) a SIP request message and stores (112) all relevant information from the SIP request message in the data store. Relevant call data is any data associated with a call that the system may use to route the call to a particular destination. Relevant call data may include data extracted from the SIP message itself (e.g., type of call, identity of the caller, etc.) or data about non-SIP related attributes of the call (e.g., the time the call was received).

The access process also selects (114) the appropriate media service application to route the call based on some selection criteria. The selection criteria with which the access process selects the media service application may be some attribute of the SIP request message attributes, call attributes, caller profile data, and caller authentication data. For example, calls to 1-800 numbers are routed to one set of live video broadcast servers for registered customers and another set of on-demand video servers for unregistered customers.

Once the access process determines the appropriate media service application to route the call, the access process 90 verifies (116) that the customer has access rights to the selected media service application. If the access process determines that the customer does not have access rights, the access process denies (118) service. If the customer does have access rights, then the access process connects (120) the caller to the requested media application. The call access process can limit access based on any number of criteria, such as a usage parameter (e.g., the total number of times accessed in a certain period or total minutes used during a period), or on one or more pieces of customer-entered data, such as the customer's account number, user ID, or password.

The call control process 92 receives call control requests from external processes (e.g., the access process 90) and routes the calls to an appropriate media service application. For example, if a customer is using a media service application that requires them to renew their membership using another media service application, the call control process would be invoked to transfer the call between applications and then return it to the original media service application. Similarly, if a customer sends a SIP request message that requests information from a third party media service application (e.g., audio feed of a speech by the Federal Reserve Board chairman) the access process verifies the access rights of the customer, and, if valid, the call control process routes the request to the proper URI location of the requested media application. Similarly, if the customer service center receives a SIP request message from a customer that requests frequently requested information (e.g., operating hours of a retail store), the call control process may route the request to the appropriate URI associated with an automated messaging application configured to automatically provide the requested information.

Other implementations are within the scope of the claims. For example, a customer service center may include a media gateway for transmission over a traditional telephony time division multiplexed (TDM) T1 line.

What is claimed is:

1. A method comprising:
receiving at a server associated with a customer service center a session initiation protocol message from a session initiation protocol user agent, the session initiation protocol message including identification information of a user associated with the session initiation protocol user agent; and
by machine, adding information about the user to one or more buddy lists that are subscribed to by customer service representatives of the customer service center.

2. The method of claim 1 wherein adding information about the user to one or more buddy lists selected from a plurality of buddy lists comprises:
by machine, selecting one or more buddy lists to which to add information about the user.

3. The method of claim 2 wherein the information comprises user profile information.

4. The method of claim 3 wherein user profile information includes one or more of the following: an address; an age; and language skills.

5. The method of claim 1 further comprising:
displaying identification information of the user on displays of subscribers of the selected buddy lists.

6. The method of claim 1 wherein the session initiation protocol message also includes a universal resource locator indicative of a webpage being displayed to the user.

7. The method of claim 6 wherein adding information about the user to one or more buddy lists comprises:
by machine, selecting one or more buddy lists to which to add information about the user based on the universal resource locator in the received message.

8. The method of claim 1 further comprising:
displaying identification information of the user on displays of subscribers of the selected buddy lists.

9. The method of claim 1 further comprising:
receiving at a web server a request from a network device associated with a user for a web page of a web site associated with the customer service center, wherein the web page contains a request for identification information from the user;
automatically transmitting one or more components of a web services user agent to the network device associated with a user in response to the received web page request, wherein the web services user agent is configured to automatically generate and transmit a session initiation protocol registration message to the session initiation protocol server, the session initiation protocol registration message including identification information entered by the user in response to request for identification information contained in the web page.

10. The method of claim 9 wherein the request for identification information comprises a request for login information.

11. The method of claim 10 wherein the login information comprises a user name and password.

12. The method of claim 9 wherein the session initiation protocol server comprises a session initiation protocol registration server and a session initiation protocol presence server.

13. The method of claim 9 where the web services user agent is further configured to handle session initiation protocol communication following with the session initiation protocol registration message.

14. The method of claim 9 further comprising:
receiving at a web server a request from a network device for a web page of a web site associated with the customer service center;
automatically transmitting one or more components of a web services user agent to the network device associated with the user in response to the received web page request, wherein the web services user agent is configured to automatically generate and transmit a session initiation protocol message to the session initiation protocol server, the session initiation protocol message including a universal resource locator of a webpage loaded in a web browser running on a device associated with the user.

15. The method of claim 14 wherein the web services user agent is further configured to periodically generate and transmit to the session initiation protocol server a session initiation protocol message including a universal resource locator of a webpage loaded in a web browser running on a device associated with the user.

16. The method of claim 15 further comprising:
updating the selected buddy lists with the universal resource locator received in the most recent session initiation protocol message.

17. The method of claim 15 wherein the web services user agent is configured to capture a universal resource locator of a website loaded in a web browser running on a device associated with the user only if the universal resource locator is associated with a web site associated with the customer service center.

18. A method comprising:
receiving a session initiation protocol message from a remote session initiation protocol user agent, wherein the message includes identification information of a user and a universal resource locator of a webpage that has been loaded into a web browser running on a device associated with the user; and
by machine, adding information about the user to one or more buddy lists selected from a plurality of buddy lists.

19. The method of claim 18 wherein adding information about the user to one or more buddy lists selected from a plurality of buddy lists comprises:
by machine, selecting one or more buddy lists to add information about the user based on the universal resource locator in the received message.

20. The method of claim 18 wherein adding information about the user to one or more buddy lists selected from a plurality of buddy lists comprises:
by machine, retrieving information about the user from a storage device; and
by machine, selecting one or more buddy lists to add information about the user based on the retrieved information.

21. The method of claim 20 wherein the retrieved information comprises user profile information.

22. The method of claim 21 wherein user profile information includes one or more of the following: an address; an age; and language skills.

23. The method of claim 18 further comprising:
subscribing customer service representatives of a customer call center to one or more of the plurality of buddy lists.

24. The method of claim 18 further comprising:
receiving a subsequent session initiation protocol message from a remote session initiation protocol user agent, wherein the message includes a universal resource locator of a webpage that has been loaded into a web browser running on a device associated with the user; and
by machine, updating the one or more selected buddy lists with the universal resource locator in the received subsequent message.

25. A system comprising:
a session initiation protocol server associated with a customer service center, wherein the session initiation protocol server is configured to receive a session initiation protocol registration message from a user and, in response, add information about the user to one or more buddy lists selected from a plurality of buddy lists subscribed to by customer service representatives of the customer service center; and
a web services user agent associated with a user device, wherein the web services user agent is configured to automatically generate and transmit a session initiation protocol registration message to the session initiation protocol server.

26. The system of claim 25 wherein the session initiation protocol server comprises a session initiation protocol registration server and a session initiation protocol presence server.

27. The system of claim 25 wherein the session initiation protocol server is further configured to retrieve information about the user from a storage device and select one or more buddy lists to add information about the user based on the retrieved information.

28. The system of claim 25 wherein the web service user agent is further configured to capture a universal resource locator of a webpage loaded in a web browser running on a device associated with the user, generate a session initiation protocol message that includes the universal resource locator of the webpage, and transmit the session initiation protocol message to the session initiation protocol server.

29. The system of claim 27 wherein the session initiation protocol server is configured to add the received universal resource locator of the webpage to the selected buddy lists.

30. The system of claim 25 further comprising:
a call controller configured to receive a request from a customer service representative to open a session initiation protocol media session with the user, and, in response, open a media session using a session initiation protocol back-to-back user agent.

31. The system of claim 30 wherein the request from a customer service representative comprises a mouse click on a active area of a graphical user interface.

32. A method for automatically connecting a first session initiation protocol user agent with a second session initiation protocol user agent, the method comprising:
by machine, determining that the first session initiation protocol user agent should be connected to the second session initiation protocol user agent based on a set of rules that define when a first session initiation protocol user agent should be connected to a second session initiation protocol user agent without a request to connect from either the first or second session initiation protocol user agent; and
by machine, connecting the first and second session initiation protocol user agents using a session initiation protocol back-to-back user agent.

33. The method of claim 32 wherein the set of rules also define a media type for the connection.

34. The method of claim 33 wherein the media type is instant messaging.

35. The method of claim 33 wherein the media type is voice.

36. The method of claim 33 wherein the media type is video.

37. The method of claim 32 wherein the back-to-back user agent is configured to hide a network address of the first session initiation protocol user agent from the second session initiation protocol user agent.

38. A method for automatically connecting a first session initiation protocol user agent with a second session initiation protocol user agent, the method comprising:
receiving an instruction from an external software process through an application programming interface to connect a first session initiation protocol user agent with a second session initiation protocol user agent; and
by machine, connecting the first and second session initiation protocol user agents using a session initiation protocol back-to-back user agent.

39. The method of claim 38 wherein the instruction further comprises information specifying a media type for the connection.

40. The method of claim 39 wherein the media type is voice.

41. The method of claim 39 wherein the media type is instant messaging.

42. The method of claim 39 wherein the media type is video.

43. The method of claim 38 wherein the back-to-back user agent is configured to hide a network address of the first session initiation protocol user agent from the second session initiation protocol user agent.

44. The method of claim 38 wherein the external software process comprises a predictive dialer program.

45. A method for automatically connecting a first session initiation protocol user agent with a second session initiation protocol user agent, the method comprising:
receiving an instruction from the first session initiation protocol user agent to connect the first session initiation protocol user agent with a second session initiation protocol user agent; and
by machine, connecting the first and second session initiation protocol user agents using a session initiation protocol back-to-back user agent.

46. The method of claim 45 wherein the instruction further comprises information specifying a media type for the connection.

47. The method of claim 46 wherein the media type is voice.

48. The method of claim 46 wherein the media type is instant messaging.

49. The method of claim 33 wherein the media type is video.

50. The method of claim 45 wherein the back-to-back user agent is configured to hide a network address of the first session initiation protocol user agent from the second session initiation protocol user agent.

51. The method of claim 45 wherein the first session initiation protocol user agent is associated with a customer service representative of a customer service center.

52. The method of claim 51 wherein the second session initiation protocol user agent is associated with a user of the customer service center.

53. The method of claim 52 further comprising:
by machine, generating the instruction in response to receiving an indication that the customer service agent has clicked on an active area associated with the user on a graphical user interface.
